(19) United States
(12) Patent Application Publication
(10) Pub. No.: US 2004/0091270 A1
(43) Pub. Date: May 13, 2004

(54) Optical transmitter receiver for free space optical communication and network system and application apparatus thereof

(76) Inventors: Youngwan Choi, Seoul (KR); Kyuman Cho, Seoul (KR)

Correspondence Address: Fleshner & Kim, PO Box 221200, Chantilly, VA, 22151-1200, US

(21) Appl. No.: 10/381,817

(22) PCT Filed: Aug. 1, 2001
(86) PCT No.: PCT/KR01/01309

(51) Int. Cl. H04B 10/24

(52) U.S. Cl. 398/130

(57) ABSTRACT

The present invention relates to the optical transmitter, receiver and application apparatus thereof for OWLL (Optical WireLess Link) which transmits and receives the optical signals through the free space and FSON (Free Space Optical Network) system using OWLL. Photonic devices such as laser diode and photo detector and electronics for driving the photonic devices are formed directly on a single printed circuit board as a standardized module and the PCB is assembled with optical instrument which is also manufactured as a standardized optical module. Then, the optical transmitter, receiver and application apparatus thereof becomes small, light, cost-effective, multi-functional and reliable.

### FIELD OF THE ART

The present invention relates to a transmitter, receiver and application apparatuses thereof enabling an optical wireless link (“OWLL”) using communication method in which optical signals are transmitted/received through the free space, i.e., the air, and a free space optical network (“FSON”) system using the OWLL.

### BACKGROUND OF THE INVENTION

The 21th century information communication society requires a social environment in which the subscribers can exchange the large amount of information at high speed, and such high speed communication becomes possible due to the improvements of the wireless communication technique of high frequency band and high speed optical communication technique using optical fibers. The study of optical communication which started in 1970s has progressed recent ten and some years to minimize the transmission loss to extend the transmission distance and to transmit a large amount of information at high speed, and now the optical communication system is in the stage of practical use, that is, the band width of the core optical communication network is over 100 Gbps, and it may reach some Tbps by 2000s. However, the technique providing the information at over tens of Mbps speed for the final user or subscriber is not developed so much.

Roles of optical communication technique, which secure the high speed, parallelism, and large capacity, are very important to establish very high speed broadband integrated services communication network. The conventional wireless communication system, which transmits data at tens of kbps speed in PCS system of 2 GHz, is not enough to provide wireless multimedia service. In this regard, studies about IMT-2000 having maximum data transmission rate of 2 Mbps, which is called as the third generation wireless communication, are in progress, and now it is in the stage of practical user. However, the next generation multimedia system for very high rate data transmission such as HDTV requires tens to hundreds Mbps rate data transmission for the subscribers, therefore, the IMT-2000 cannot be a final solution.

The next generation multimedia is a system and service which make various information such as text, data, audio, graphic, photo, animation, image, etc. to produce, collect, transmit, and process integrally, and the multimedia industry means the industrial field related to those activities. Recently, the multimedia information industry goes in the direction of digitalization, bi-directionization, asynchronization, and integrallization of image, sound, etc. in the content, form, and exchange method due to the development of the technologies in computer and communication fields. The effect of the technology development to the industrial structure is evolutional. For the most important obstacle to the present multimedia service, the performance of the communication network having insufficient capacity is pointed out, and the role of locomotive to progressive reproduction of the next generation multimedia is given to providing the communication network of very high speed and large capacity for individual subscribers economically.

It is considered that the only network technology which able to provide the very high speed and large capacity information for individual subscribers is the fiber-to-the-home (“FTTH”), however, in case of the FTTH, the installation is difficult, and the cost of installation is large because additional cost is required to lay the optical fiber underground as well as the communication device. Moreover, it requires additional steps of aligning between the optical fiber and laser diode (“LD”) or photo detector (“PD”) for the optical transmitting/receiving module. The present invention pursues very economical and easily installable optical transmitting/receiving module which enabling FSON which can solve the problems of the FTTH instead of the wireless communication network using coaxial cables and microwave (“MW”) transmitting/receiving device such as high frequency oscillator, modulator, etc. to connect the base station (“BS”) and the central base station (“CBS”) such as mobile service switching center.

Until now, the FSON is used as the back-up system for the existing wire network utilizing the advantages that the service can be provided instantly because the installation is easy and fast and that the communication protection is guaranteed physically, or most efforts are concentrated on development of high power transceiver focusing point-to-point connection considering quick installation, therefore, it is not used so practically.

Therefore, the present invention suggests economical transmitting/receiving modules for FSON suitable to provide the very high speed and large capacity information for a plurality of users or subscribers stably using OWLL and FSON system using OWLL different from the existing simple point-to-point type.

### SUMMARY OF THE INVENTION

The new OWLL and FSON system leaded to resolve the problems and limits of the above described convention technology has differences to the conventional wire/wireless communication network in that they can provide the complex multimedia communication service such as high-speed internet, point-to-point and point-to-multiple point data, audio, and image transmission with very high speed, large capacity, stability, and efficiency preparing the next generation multimedia era.

The OWLL and FSON system in which basic blocks are set according to the transmission distance and transmission rate and such blocks are combined in various way to provide very high speed and large capacity information without being affected by the position and distance of the subscriber is the communication system of completely new concept for very high speed and large capacity communication system. The OWLL and FSON system should be robust to the turbulence of the air, temperature gradient, snow, rain, fog, etc. and able to change the intensity and direction of the optical output, bit-rate, etc. adaptively according to the surrounding environments. In addition, it should be constituted as a system able to monitor, control, and operate the transmitting/receiving status integrally.

The necessities for OWLL and FSON system are the economical transmitter, receiver, and various application apparatuses thereof enabling the OWLL and FSON system. Therefore, the object of the present invention is to provide the transmitter, receiver, and various application apparatuses thereof for OWLL and FSON.

Another object of the present invention is to provide the transmitter, receiver, and various application apparatuses thereof for OWLL, which are small, light, cheap, stable, and reliable.

To achieve the above objects, the present invention provides transmitting/receiving apparatuses for providing OWLL and FSON information communication service in which light source(s) such as laser diode, photo-electric device(s) for optical transmission and reception such as photo detector, and related circuit(s) are formed on one printed circuit board, and the printed circuit board and the optics modules are manufactured as standardized modules to be easily assembled with each other.

That is, a transmitter for free space optical communication according to the present invention comprises: a light source formed on a printed circuit board; a photo detector formed on the printed circuit board for detecting the light from the light source; a current driver and controller circuit integrally formed on the printed circuit board having a first terminal for receiving input signals, a second terminal for bias-in, a third terminal connected to the light source for outputting output signals to the light source and a fourth terminal connected to the photo detector for receiving output control signals for controlling the output of the light source from the photo detector; and an optics module formed to be assembled with the printed circuit board for receiving the light from the light source and transmitting the received light to the external free space.

Here, it is preferable that the light source is a laser diode or a light emitting diode, the light source and the photo detector may be bonded to the printed circuit board using flip-chip bonding method, and the current driver and controller circuit may include a light source driver circuit for driving the light source by outputting pulse via the first terminal and an automatic output control circuit for controlling the output of the light source driver circuit according to the output control signal inputted via the fourth terminal.

In addition, the optics module comprises a lens; and a lens holder being able to adjust the focal length of the lens, the lens is an aspheric lens or a Fresnel lens, and the printed circuit board and the optics module can be assembled using screw units formed in the printed circuit board and the optics module, respectively. On the other hand, the light from the transmitter is preferably eye-safe.

The output of the light source and the driving current of the current driver and controller circuit have appropriate values according to the transmission distance required for the transmitter to manufacture the transmitters as standardized blocks for various transmission distance, and screw units to assemble the printed circuit board and the optics module are standardized thereby various optics modules having lenses of different sizes can be assembled with the printed circuit board.

On the other hand, a receiver for free space optical communication according to the present invention comprises: a photo-detecting module including a photo detector formed on a printed circuit board; an optical receiver circuit, integrally formed on the printed circuit board, having a first terminal connected to the photo-detecting module for receiving input signals from the photo-detecting module, a second terminal for bias-in, and a third terminal for outputting electric signals generated by transforming the input signals from the photo-detecting module; and an optics module formed to be assembled with the printed circuit board for receiving the light from the external free space and transmitting the received light to the photo detector of the photo-detecting module.

Here, the photo-detecting module includes a preamplifier, formed on the printed circuit board and connected to the photo detector, for amplifying the signals obtained from the photo detector, and in this case, the optical receiver circuit comprises: a signal amplifier for amplifying the signals transferred from the photo-detecting module via the first terminal; an automatic gain controller for controlling the gain of the signal amplifier; a data recovery circuit for recovering data from the signals transferred from the signal amplifier; and a clock generator for generating clock signals using the signals transferred from the signal amplifier and transferring the clock signals to the data recovery circuit. If not, the optical receiver circuit includes a preamplifier.

It is preferable that the optical receiver circuit has a fourth terminal for monitoring the magnitude of input signals at the outside of the optical receiver circuit. The fourth terminal may be connected to a display unit for displaying the magnitude of input signals, or the magnitude of input signals can be transferred to the base station at the outside of the receiver.

A transceiver for free space optical communication according to the present invention comprises: a first light source formed on a printed circuit board; a first photo detector formed on the printed circuit board for detecting the light from the first light source; a first current driver and controller circuit integrally formed on the printed circuit board having a first terminal for receiving input signals, a second terminal for bias-in, a third terminal connected to the first light source for outputting output signals to the first light source, and a fourth terminal connected to the first photo detector for receiving output control signals for controlling the output power of the first light source from the first photo detector; a transmitting optics module formed to be assembled with the printed circuit board for receiving the light from the first light source and transmitting the received light to the external free space; a photo-detecting module including a second photo detector formed on the printed circuit board; a first optical receiver circuit integrally formed on the printed circuit board having a fifth terminal connected to the photo-detecting module for receiving input signals from the photo-detecting module, a sixth terminal for bias-in, and a seventh terminal for outputting electric signals generated by transforming the input signals from the photo-detecting module; and a receiving optics module formed to be assembled with the printed circuit board for receiving the light from the external free space and transmitting the received light to the second photo detector of the photo-detecting module.

Here, the transmitting optics module and the receiving optics module may face to the same side. They can have the same configuration or different configurations from each other.

In addition, the transceiver may further comprises a second optical receiver circuit integrally formed on the printed circuit board and connected to the first terminal of the first current driver and controller circuit; a third photo detector formed on the printed circuit board and connected to the second optical receiver circuit; a second current driver and controller circuit integrally formed on the printed circuit board and connected to the seventh terminal of the first optical receiver circuit; and a second light source formed on the printed circuit board, connected to the second current driver and controller circuit, and it may further comprises: a first optical fiber connected to the third photo detector; a second optical fiber connected to the second light source; and a media converter connected to the first and second optical fibers and having UTP (unshielded twisted-pair) port. Alternatively, the media converter circuit having UTP port is formed on the printed circuit board and connected to the first terminal of the first current driver and controller circuit and the seventh terminal of the first optical receiver circuit directly.

A transponder for free space optical communication according to the present invention comprises: a light source formed on a printed circuit board; a first photo detector formed on the printed circuit board for detecting the light from the first light source; a first current driver and controller circuit, integrally formed on the printed circuit board, having a first terminal for receiving input signals, a second terminal for bias-in, a third terminal connected to the first light source for outputting output signals to the first light source and a fourth terminal connected to the first photo detector for receiving output control signals for controlling the output of the first light source from the first photo detector; a multiplexer, formed on the printed circuit board and connected to the first terminal of the current driver and controller circuit, for multiplexing input signals to output to the current driver and controller circuit via the first terminal; a transmitting optics module formed to be assembled with the printed circuit board for receiving the light from the first light source and transmitting the received light to the external free space; a photo-detecting module including a second photo detector formed on the printed circuit board; a first optical receiver circuit, integrally formed on the printed circuit board, having a fifth terminal connected to the photo-detecting module for receiving input signals from the photo-detecting module, a sixth terminal for bias-in, and a seventh terminal for outputting electric signals generated by transforming the input signals from the photo-detecting module; a demultiplexer, formed on the printed circuit board and connected to the seventh terminal of the optical receiver circuit, for receiving signals from the optical receiver circuit and outputting demultiplexed signals; and a receiving optics module formed to be assembled with the printed circuit board for receiving the light from the external free space and transmitting the receiving light to the second photo detector of the photo-detecting module.

Here, the light source, first photo detector, current driver and controller circuit, and multiplexer may be formed on one substrate, and the photo-detecting module, optical receiver circuit, and demultiplexer may be formed on the other substrate. Alternatively, the light source, first photo detector, and current driver and controller circuit may be formed on one substrate, the multiplexer and demultiplexer may be formed on another substrate, and the photo-detecting module, and optical receiver circuit may be formed on another substrate. The demultiplexer and multiplexer may include add port and drop port, respectively.

Another example of the transmitter for free space optical communication according to the present invention comprises: a photo-optics module including a light source, a photo detector for detecting the light from the light source, and an optics module, formed to be integrated with the light source and the photo detector, for receiving the light from the light source and transmitting the received light to the external free space; and a current driver and controller circuit, integrally formed on a printed circuit board, having a first terminal for receiving input signals, a second terminal for bias-in, a third terminal connected to the light source for outputting output signals to the light source, and a fourth terminal connected to the photo detector for receiving output control signals for controlling the output of the light source from the photo detector; wherein the light source and the photo detector are connected to the third terminal and the fourth terminal respectively with flexible wires.

Another example of the receiver for free space optical communication according to the present invention comprises: a photo-optics module including a photo-detecting module having a photo detector, and an optics module formed to be integrated with the photo-detecting module for receiving the light from the external free space and transmitting the light to the photo detector of the photo-detecting module; and an optical receiver circuit, integrally formed on a printed circuit board, having a first terminal connected to the photo-detecting module for receiving input signals from the photo-detecting module, a second terminal for bias-in, and a third terminal for outputting electric signals generated by transforming the input signals from the photo-detecting module; wherein the photo detector and the third terminal are connected with flexible wire.

Another example of the transceiver for free space optical communication according to the present invention comprises: a transmitting photo-optics module including a light source, a first photo detector for detecting the light from the light source, and a transmitting optics module, formed to be integrated with the light source and the first photo detector, for receiving the light from the light source and transmitting the received light to the external free space; a receiving photo-optics module including a photo-detecting module having a second photo detector, and a receiving optics module formed to be integrated with the photo-detecting module for receiving the light from the external free space and transmitting the received light to the second photo detector of the photo-detecting module; a current driver and controller circuit, integrally formed on a printed circuit board, having a first terminal for receiving input signals, a second terminal for bias-in, a third terminal connected to the light source for outputting output signals to the light source, and a fourth terminal connected to the first photo detector for receiving output control signals for controlling the output of the light source from the first photo detector; and an optical receiver circuit, integrally formed on the printed circuit board, having a fifth terminal connected to the photo-detecting module for receiving input signals from the photo-detecting module, a sixth terminal for bias-in, and a seventh terminal for outputting electric signals generated by transforming the input signal from the photo-detecting module; wherein the light source and the first photo detector are connected to the third terminal and the fourth terminal respectively with flexible wires; and wherein the second photo detector and the seventh terminal are connected with a flexible wire.

### BRIEF DESCRIPTION OF THE DRAWINGS

FIG. 1 is a schematic diagram showing a transmitter for free space optical communication according to an embodiment of the present invention.

FIG. 2 is a block diagram showing an example of a current driver and controller circuit used in the transmitter shown in FIG. 1.

FIGS. 3 and 4 are schematic diagrams showing transmitters for free space optical communication according to another embodiments of the present invention.

FIG. 5 is a schematic diagram showing a receiver for free space optical communication according to an embodiment of the present invention.

FIG. 6 is a block diagram showing an example of an optical receiver circuit used in the receiver shown in FIG. 5.

FIG. 7 shows an example optics module in the receiver of FIG. 5.

FIGS. 8 and 9 are schematic diagrams showing transmitters for free space optical communication according to another embodiments of the present invention.

FIG. 10 shows a transceiver for free space optical communication according to an embodiment of the present invention.

FIG. 11 is a schematic diagram showing a transceiver for free space optical communication able to connect to the Ethernet according to another embodiment of the present invention.

FIG. 12 is a schematic diagram showing a transceiver for free space optical communication able to connect to the Ethernet via optical fiber links according to another embodiment of the present invention.

FIG. 13 shows an example of a transponder for free space optical communication according to the present invention having multiplexing/demultiplexing function.

FIG. 14 is a schematic diagram showing a transponder for free space optical communication whose transmitting and receiving parts are separated according to another embodiment of the present invention.

FIG. 15 is a schematic diagram showing a transponder for free space optical communication whose transmitting, multiplexing/demultiplexing, and receiving parts are separated according to another embodiment of the present invention.

FIG. 16 is a schematic diagram showing a transmitter for free space optical communication according to another embodiment of the present invention.

FIG. 17 is a schematic diagram showing a receiver for free space optical communication according to another embodiment of the present invention.

FIG. 18 is a schematic diagram showing a transceiver for free space optical communication according to another embodiment of the present invention.

### BEST MODE FOR CARRYING OUT THE INVENTION

Now, preferred embodiments of the present invention will be described in detail with reference to accompanying drawings.

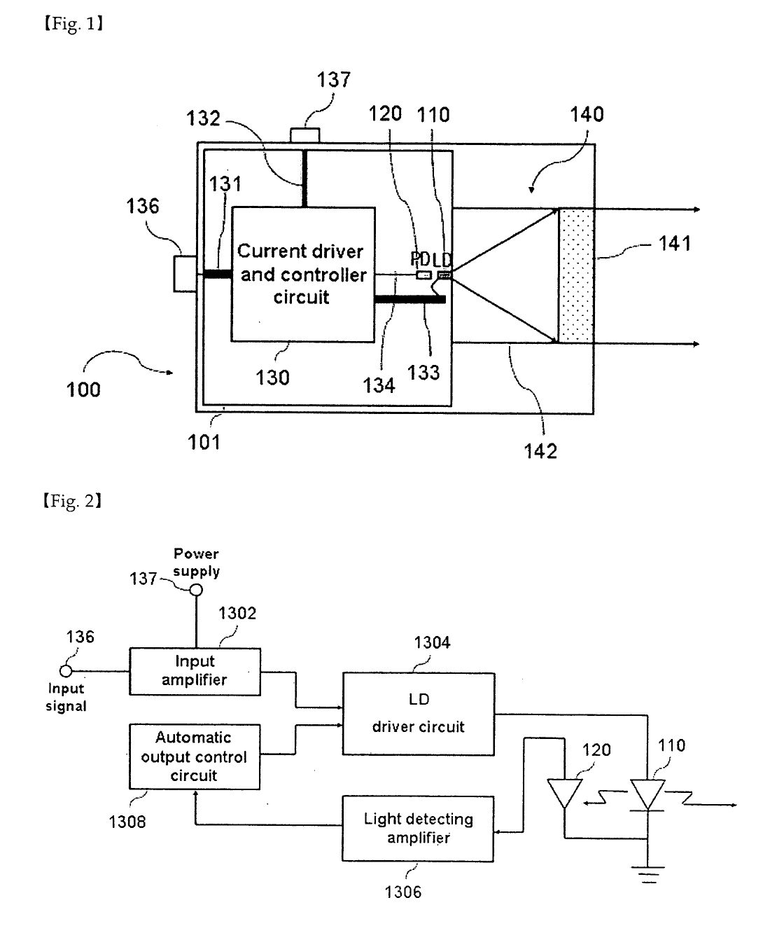

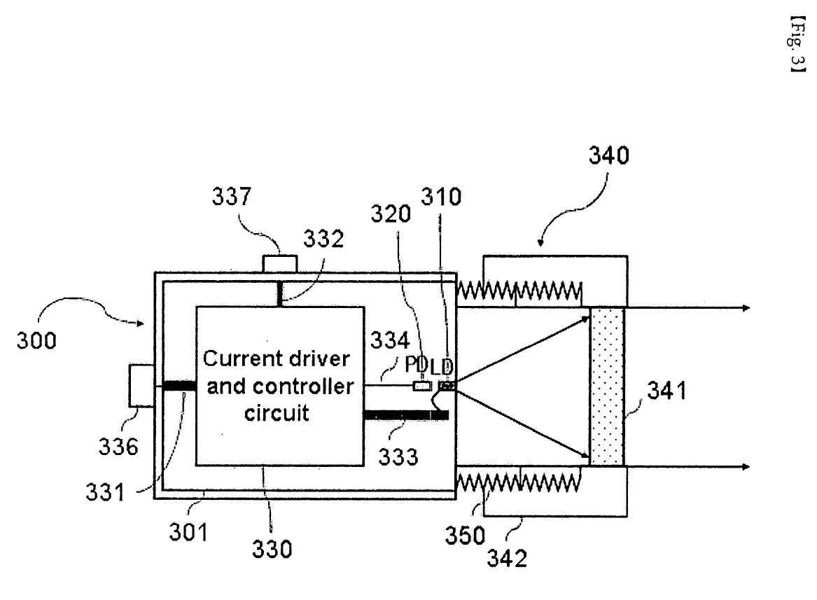

First, a structure of a transmitter for free space optical communication will be described. FIG. 1 is a schematic diagram showing a transmitter 100 for free space optical communication according to an embodiment of the present invention, and FIG. 2 is a block diagram showing an example of a current driver and controller circuit used in the transmitter shown in FIG. 1.

As shown in FIG. 1, a laser diode (“LD”) 110, which is a light source to transmit a light carrying an free space optical communication signal to the free space outside of the transmitter 100, is formed on a printed circuit board (“PCB”) 101. The light from the LD 110 is collimated through an optics module 140 and transmitted to the free space. A light emitting diode (“LED”) can be used as the light source as well as LD. For LDs, various kinds of LDs such as Febry-Perot LD, distributed feedback LD (“DFB-LD”), vertical cavity surface emitting laser (“VCSEL”), etc. can be used. It is related to the transmission distance of the transmitter which kind of light sources is used. Transmitters can be classified for very short distance (less than 100 m), short distance (50-300 m), middle distance (150-500 m), and long distance (500-2000 m), and, for example, a VCSEL having a nominal wavelength of 0.85*10−6 m is preferably used for the very short distance transmitter as the light source. In addition, the nominal wavelength of the light from the LD can be 1.3*10−6 m or 1.55*10−6 m if the transmitter according to the present invention is used for the middle distance of less than 500 m or short distance of less than 300 m free space optical communication. It is preferable that the light from the light source satisfies the safety standard for human body including the eyes.

Moreover, a photo detector (“PD”) 120 is formed on the PCB 101 adjacent to the LD 110 having a little bit of space between them to detect the light from the LD 110. For PD 120, various kinds of devices such as MSM (metal-semiconductor-metal) PD, PIN (inversely biased P-N junction) PD, APD (avalanche photodiode), etc. can be used. The PD 120 detects the light from the LD 110 and uses it as a signal to control the output of the LD 110.

A current driver and controller circuit 130 is formed also on the PCB 101 as an integrated block to drive the LCD to output a desired signal. The current driver and controller circuit 130 can be formed in various ways, and it is possible to use a ready-made block. Here, the current driver and controller circuit 130 is constituted of a standardized component to have an output of the LD 110 and a driving current of the current driver and controller circuit 130 appropriate to the transmission distance of the transmitter. That is, the transmitters of the present invention can be manufactured as the standardized modules for each transmission distance (for example, very short distance, short distance, middle distance, long distance, etc.). To do this, PCB halting appropriate LD output and driving current for each transmission distance is manufactured and it is assembled with the optics module to complete the transmitter.

The example of the current driver and controller circuit 130 is shown in FIG. 2. That is, the circuit comprises an input amplifier 1302 receiving an input signal from the outside and amplifying the signal and a LD driver circuit 1304 driving the LD 110, the light source, using the signal amplified through the input amplifier 1302, and the signal detected through the PD 120 is amplified by the light detecting amplifier 1306, transmitted to the automatic output control circuit 1308, and used to control the LD driver circuit 1304. To do this, the current driver and controller circuit 130 is electrically connected to an input terminal 136 to receive an input signal and a power terminal 137 to receive a power supply via wires 131 and 132, respectively, and it is also electrically connected to the LD 110 and PD 120 via wires 133 and 134 formed on the PCB, respectively.

The LD 110 and PD 120 are integrally formed with the current driver and controller circuit 130 on the PCB 101, and the method of forming the LD 110 and PD 120 on the PCB 101 may include filp chip bonding or wire bonding. Alternatively, after forming the LD and PD on a small ceramic substrate instead of conventional PCB, the ceramic substrate can be integrated with PCB in a hybrid form, and two substrates can be wire bonded. It is possible to use a package in which the LD and PD are mounted on TO-can.

On the other hand, the optics module 140 is constituted of a lens 141 and a lens holder 142, and it is fixed on the PCB 101 where the light source 110 is formed. The lens 141 may be an aspheric lens or a Fresnel lens. Since a Fresnel lens can be manufactured easily by using an injection method, etc., it has an advantage to reduce the manufacturing cost of the transmitter. At this time, it is preferable that the lenses are standardized for transmission distances to manufacture the transmitter. In addition, the lens holder 142 is formed to adjust the position of the lens 141 before and behind in the optics module 140 to adjust the focal distance according to the use of the transmitter. The light from the light source 110 is collimated by the lens 141 to a proper extent to be received by a receiver, and the nominal beam divergence of the light from the transmitter is 1*10−3 radian.

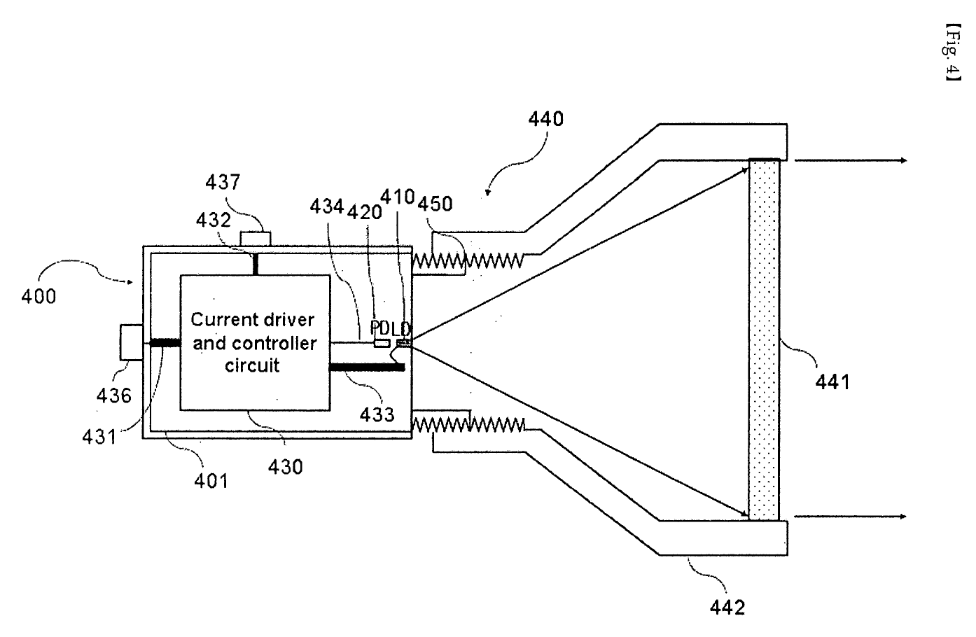

On the other hand, the optics module and PCB are formed as standardized blocks to be assembled with each other easily, and they are fixed together after assembling. FIGS. 3 and 4 show examples of the transmitter which have screw units to assemble the optics module and PCB. As shown in FIG. 3 or 4, screw units 350 in FIGS. 3 and 450 in FIG. 4 are formed on both sides of the optics modules 340 in FIGS. 3 and 440 in FIG. 4 and the PCBs 301 in FIGS. 3 and 401 in FIG. 4 to assemble two parts by turning the screws. The screw units can be formed integrally with the PCB or optics module, or they can be formed to be assembled with the PCB or optics module. In FIGS. 3 and 4, the assembled forms by turning the screws are shown. In FIGS. 3 and 4, other components have similar structures as described with reference to FIG. 1, the similar components are indicated as similar symbols. To form screw units for the optics module and PCB, it is possible to form frames surrounding the optics module or PCB and form screw units therein.

When the screw units are formed, it is preferable that the screw units of the standardized gauge are formed in optics module having lenses of various sizes and PCBs on which photo-electronic devices and circuits which are also standardized for each of the transmission distances are formed, two parts of which can be assembled according to the needs. Then, it is possible to optionally mount lenses of small or large diameter according to the needs such as the transmission distance, reliability, etc. for the same PCB. That is, according to the present invention, it is very easy to manufacture a transmitter of proper standard because the PCB and optics module can be easily assembled by a method of forming screw units, etc.

In addition, it is preferable that an output window transparent to the wavelength of the light source is provided outside of the optics module to install the transmitter outdoors. A protective cover or heater to confront the change of humidity or temperature can also be provided.

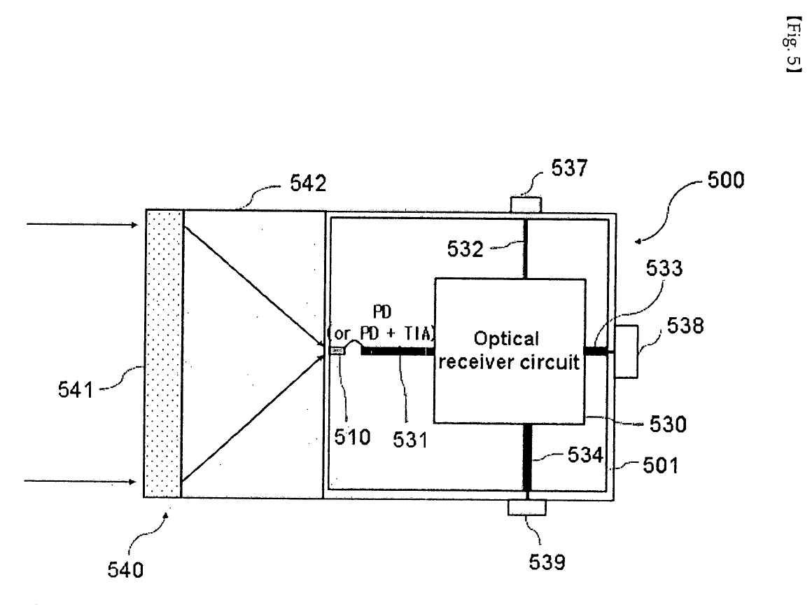

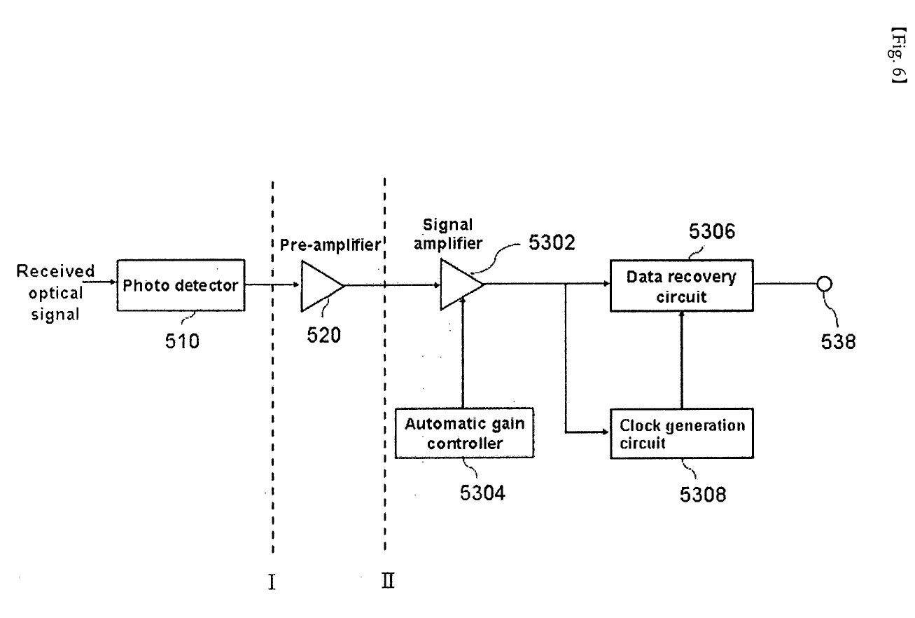

Now, a structure of a receiver free space optical communication will be described. FIG. 5 is a schematic diagram showing a receiver for free space optical communication according to an embodiment of the present invention, and FIG. 6 is a block diagram showing an example of an optical receiver circuit used in the receiver shown in FIG. 5.

In the receiver 500, a PD 510 to detect a light received from the free space outside of the receiver is formed on a PCB 510. For PD 510, various kinds of devices such as MSM PD, PIN PD, APD, etc. can be used as used in the transmitter 100. The PD 510 is attached on the PCB 501 using wire bonding or flip chip bonding and connected to an optical receiver circuit 503 formed on the PCB 501 via a wiring 531. Alternatively, after forming the PD on a small ceramic substrate instead of conventional PCB, the ceramic substrate can be integrated with PCB in a hybrid form, and two substrates can be wire bonded. It is possible to use a package in which the PD or both PD and pre-amplifier are mounted on TO-can.

The optical receiver circuit 530 can be formed as an example shown in FIG. 6, and it is possible to use a ready-made circuit block as in the transmitter. The optical receiver circuit 530 may be constituted of a pre-amplifier (“TIA” which is a trans-impedance amplifier) 520 to amplify the signal from the PD 510, a signal amplifier 5302 to amplify the signal transmitted from the pre-amplifier 520, an automatic gain controller 5304 to control the gain of the received signal, a data recovery circuit 5306 to recover the data from the received signal, a clock generation circuit 5308 to extract the clock from the received signal and transmit it to the data recovery circuit 5306, etc. Here, the pre-amplifier 520 can be included in the optical receiver circuit 530 or can be formed together with the PD 510 as a block. If the pre-amplifier 520 is formed in the optical receiver circuit 530, the optical receiver circuit has a constitution shown in the left part of the line II of FIG. 6. If the pre-amplifier is formed together with the PD as a block, the optical receiver circuit has a form shown in the right part of the line II of FIG. 6.

The optical receiver circuit 530 is connected to an output terminal 538 to output electrical signal generated and a power terminal 537 to receive a power supply via wires 533 and 532, respectively, and it may further include an additional terminal 539 to monitor the level of the output signal.

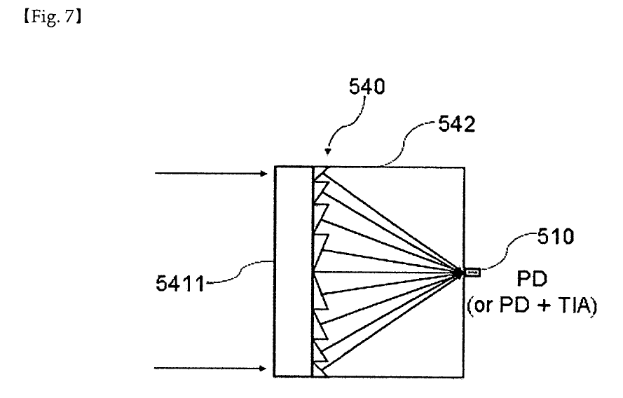

The light received from the outside is collected via an optics module 540 and transmitted to the PD 510. The optics module 540 is constituted of a lens 541 and a lens holder 542 similar to the transmitter 100. FIG. 7 shows an example optics module used in the receiver 500 of FIG. 5. As shown in FIG. 7, the efficiency of the beam collection can be maximized if a Fresnel lens 5411 is used. In addition, since the Fresnel lens can be easily manufactured by using a very economical way such as an injection method, etc., it is more advantageous to secure economical efficiency of transmitter and/or receiver for FSON than any other lenses. Moreover, since the Fresnel lens has a large numerical aperture, which makes the acceptance angle large, it is possible to receive the light signal easily and effectively.

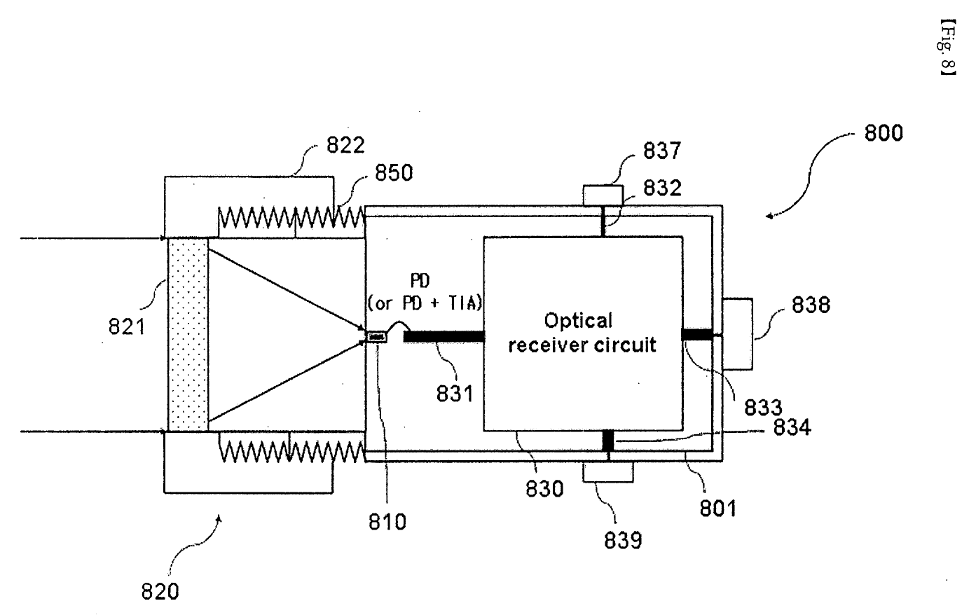

It is preferable to make the optics module and PCB of the receiver as standardized blocks to be assembled with each other easily as in the transmitter. FIGS. 8 and 9 show examples of the receiver which have screw units to assemble the optics module and PCB. As shown in FIG. 8 or 9, screw units 850 in FIGS. 8 and 950 in FIG. 9 are formed on both sides of the optics modules 840 in FIGS. 8 and 940 in FIG. 9 and the PCBs 801 in FIGS. 8 and 901 in FIG. 9 to assemble two parts by turning the screws. In FIGS. 8 and 9, the assembled form by turning the screws is shown. As in the transmitter, screw units can be formed integrally with the PCB or optics module, or it can formed to be assembled with them. Screw units may be formed to have a standard gauge able to assemble the lens of a proper size according to needs. In FIGS. 8 and 9, other components have similar structures as described with reference to FIG. 5, the similar components are indicated as similar symbols. To form screw units for the optics module and PCB, it is possible to form frames surrounding the optics module or PCB and form screw units therein.

The fact that the transmitter and receiver should constantly have reliability is a very important function of the free space optical communication system. In case of OWLL, there is a possibility for the intensity of a signal to be degraded if the alignment between the transmitter and the receiver becomes wrong different from the optical fiber communication link. Therefore, the alignment between the transmitter and the receiver should be monitored constantly if it maintains good condition or not. For this purpose, a monitoring terminal 539 to monitor the intensity of the received signal constantly can be provided according to the embodiment of the present invention as shown in FIG. 5. In addition, it is possible to display the intensity of the signal received to the receiver by connecting the monitoring terminal 530 to a display device (not shown). As the display device, an LED of a visible ray can be used. Addition to the displaying the intensity externally, it is possible to report the extent of degradation of the signal obtained on the optical receiver circuit to the central base station which manages and administrates the whole FSON system.

The conventional transceiver for fiber optical communication using optical fiber needs a precise packaging which spends a long time to align and pig-tail between the LD and the fiber or between the PD and the fiber to an extent of minuteness of some μm. Therefore, the cost of manufacturing the conventional transceiver is very high. On the other hand, the transceiver for OWLL and FSON as suggested in the present invention has a advantage to be manufactured very economically. That is, since the transceiver for OWLL and FSON as suggested in the present invention is very economical, the FSON system can be more economical than FTTH (fiber-to-the-home) system.

In case of the receiver, it is preferable that it accepts only the light in which the transmitter outputs selectively. The light in which the transmitter outputs is the light having nominal wavelength of 0.85*10−6 m, 1.3*10−6 m, 1.55*10−6 m, etc. as described above. For this purpose, it is preferable to provide an input window transparent only to the light in which the transmitter outputs and able to shield the normal light in front of the optics module of the receiver. To install the receiver outdoors, it may also need to provide a protective cover or heater.

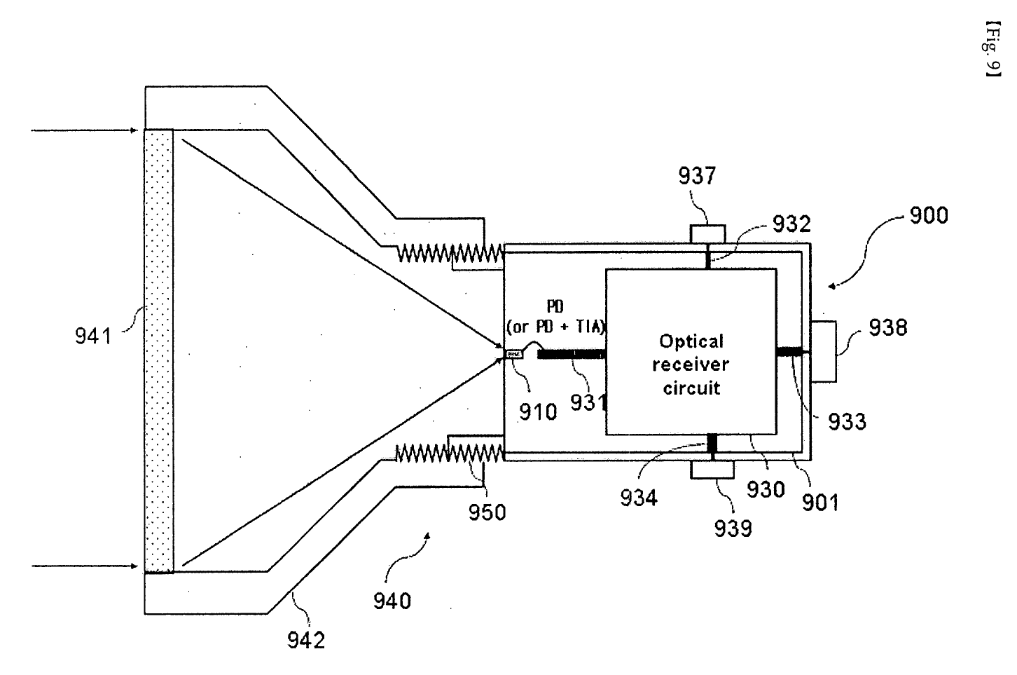

FIG. 10 shows an all-in-one transceiver (“TRX”) for OWLL and FSON system in which a transmitter and a receiver are formed as one module. Since the OWLL and FSON system is basically a bi-directional communication system, the transmitter and the receiver tend to be used together other than used separately. The transmitter in FIG. 10 is that the transmitter and the receiver shown in FIGS. 1 and 5, respectively, are formed integrally for this purpose.

As shown in FIG. 10, a transmitting optics module 1040 and a receiving optics module 1140 are assembled with a PCB 1001, and a circuit for transmitting and receiving 1030 and 1130 are formed integrally on the PCB 1001. An LD 1010 is formed on the PCB 1001 adjacent to the transmitting optics module 1040. A PD 1020 for monitoring the output of the LD 1010 is formed on the PCB 1001 of opposite side to the transmitting optics module 1040 adjacent to the LD 1010, and the LD 1010 and the PD 1020 are connected to the current driver and controller circuit 1030. A PD 1110 is formed adjacent to the receiving optics module 1140, and the PD 1110 is connected to the optical receiver circuit 1130. The other structure is similar to the transmitter and the receiver shown in FIGS. 1 and 5, respectively. Since the circuits for transmitting and receiving 1030 and 1130 are formed on one PCB 1001, it is possible for two circuits to receive electric power supply from one power terminal 1037.

The transmitting and receiving optics modules 1040 and 1140 can be manufactured as modules having standardized gauge to assemble with the PCB 1001, and the assembling method can be the same as used in the transmitter 100 or the receiver 500. In addition, the transceiver 1000 of the present invention shown in FIG. 10 can have all characteristics of the transmitter 100 and the receiver 500 described above.

For the transmitting and receiving optics modules 1040 and 1140, it is possible to use the same standard or different standards. Moreover, in the transceiver shown in FIG. 10, the transmitting and receiving optics modules 1040 and 1140 are installed in the same direction, however, they can be installed in different directions. For this purpose, the positions of the circuits and optical devices formed on the PCB can be properly adjusted.

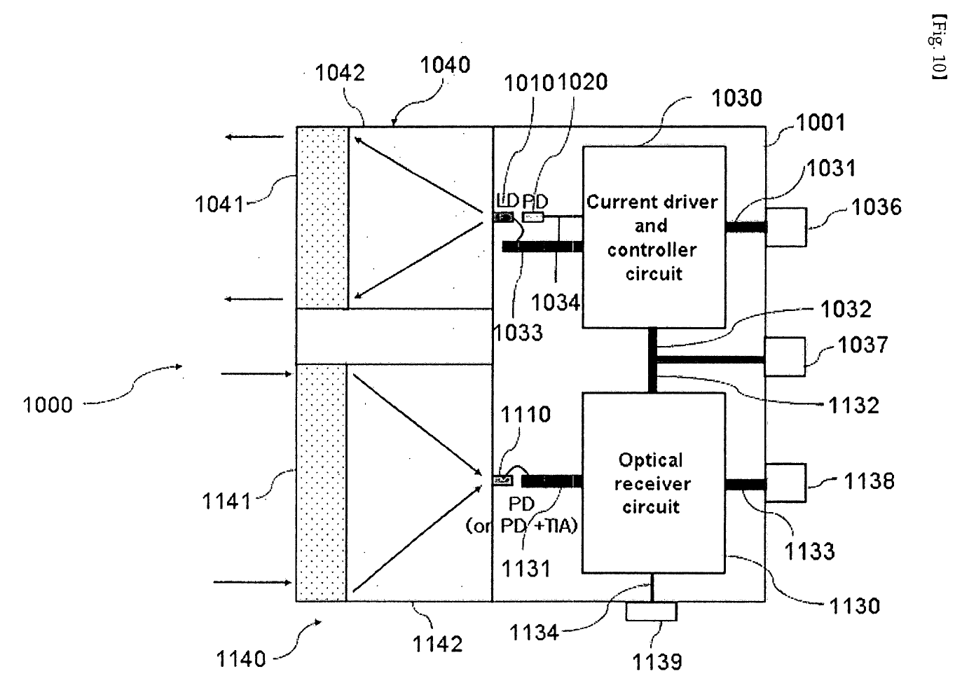

On the other hand, OWLL and FSON system of the present invention can be effectively used by combining with the existing Ethernet or LAN. For this purpose, Ethernet signals and signals of the optical transceiver of the present invention are transformed to each other using a media converter. The device for this purpose is shown in FIG. 11.

That is, a media converter circuit 1110 for data transformation is formed on a PCB 1101 of a transceiver similar to that shown in FIG. 10 and connected to a current driver and controller circuit 1030 of the transmitting side and an optical receiver circuit 1130 of the receiving side, respectively. An unshielded twisted-pair (“UTP”) port 1111 is provided to the media converter circuit to connect to the Ethernet.

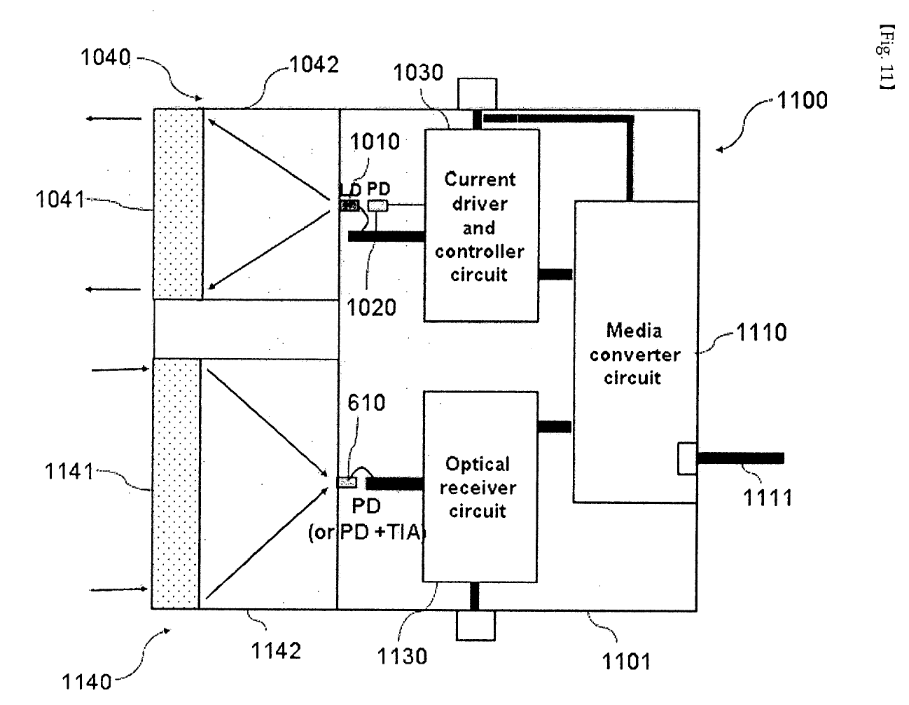

However, sometimes the transceiver for OWLL and the media converter should be connected using an optical fiber link because the UTP cable for Ethernet is not able to use for long distance. For example, it is the case that the position of the transceiver for OWLL is far from the position of the subscriber such as a roof of the building. Then, the data signal of the transceiver should be conveyed to the media converter near the subscriber via light. For this purpose, as shown in FIG. 12, a transmitting/receiving module to carry the signal transmitted/received by the transmitting/receiving module for OWLL via an optical fiber link is needed. Therefore, the apparatus 1200 is constituted to have two light sources 1010 and 1160, current driver and controller circuits 1030 and 1150, photo detecting devices 1110 and 1060 for receiving, and optical receiver circuits 1130 and 1050, and those optical devices and circuits are all formed on one PCB 1201.

Data of the signal, received via the receiving optics modules 1140 and detected by the first photo detecting device 1110, are recovered by the first optical receiver circuit 1130 and transformed by the second current driver and controller circuit 1150. The second light source, LD, 1160 is driven using the transformed signal, and the signal from the LD 1160 is transmitted through an optical fiber cable 1170 to a media converter 1210 outside of the apparatus 1200 to be transformed to the signal for Ethernet. The transformed signal is connected to the Ethernet through an UTP port 1211 of the media converter 1210. On the contrary, the signal from the Ethernet is conveyed to the media converter 1210 through the UTP port 1211, transformed there, and carried to the transceiver 1200 for OWLL via optical fiber link 1070 in the building. The transceiver 1200 for OWLL includes the second photo detecting device, PD, 1060 to detect the signal transmitted through the optical fiber link 170, and the signal detected by the PD 1060 is transformed by the second optical receiver circuit 1050, transformed again through the first current driver and controller circuit 1030, and transmitted to the outside via the first light source 1010 and the transmitting optics module 1040.

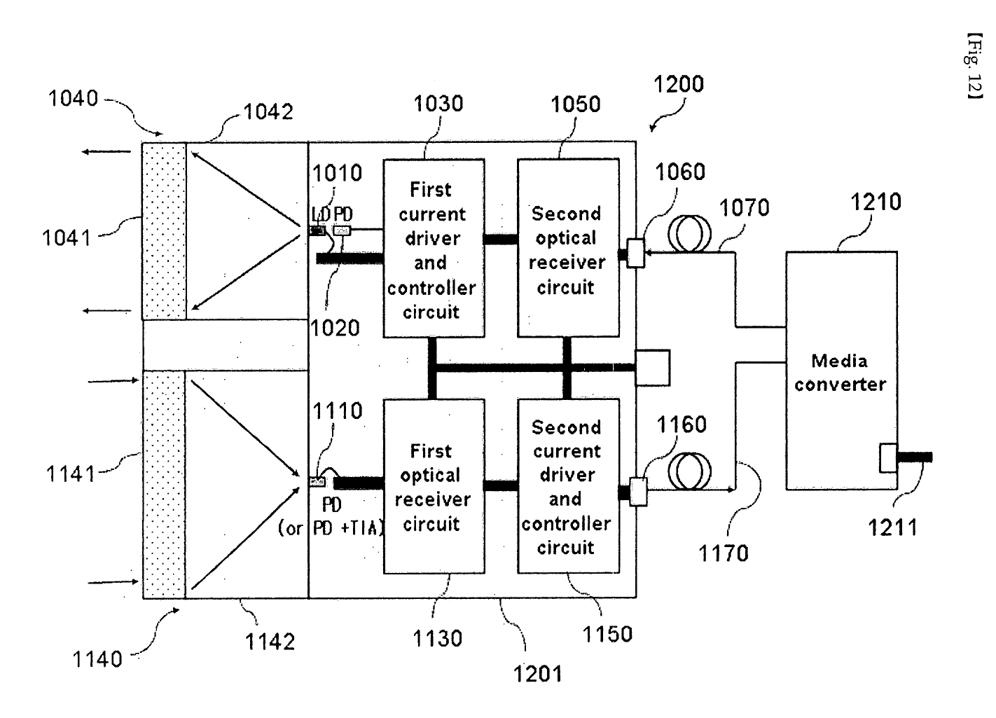

The subscriber network using FSON can be tried in various forms. Both ring type network and star type network using ATM (asynchronous transfer mode) are possible, and tree, bus, and mesh type networks are also possible. When the network is formed, sometimes there is a case that a node uses some data by itself and relays the other data to another node after transmitting/receiving data of large bandwidth from/to the central base station. In this case, a transmitting/receiving module needs a function of multiplexing/demultiplexing. FIG. 13 shows an example of a transponder for OWLL according to the present invention having multiplexing/demultiplexing function.

As shown in FIG. 13, a multiplexer (“MUX”) 1080 is connected to the current driver and controller circuit 1030 of the transmitting side to multiplex the data transmitted from the input port 1090 and transmit them to the current driver and controller circuit 1030, and a demultiplexer (“DEMUX”) 1180 is connected to the optical receiver circuit 1130 of the receiving side to demultiplex the signals received from the free space and transmit them to the output port 1190. The current driver and controller circuit 1030, MUX 1080, optical receiver circuit 1130, and DEMUX 1180 are formed on the same PCB 1301, and the other structures are similar to those in the transceiver 1000 shown in FIG. 10.

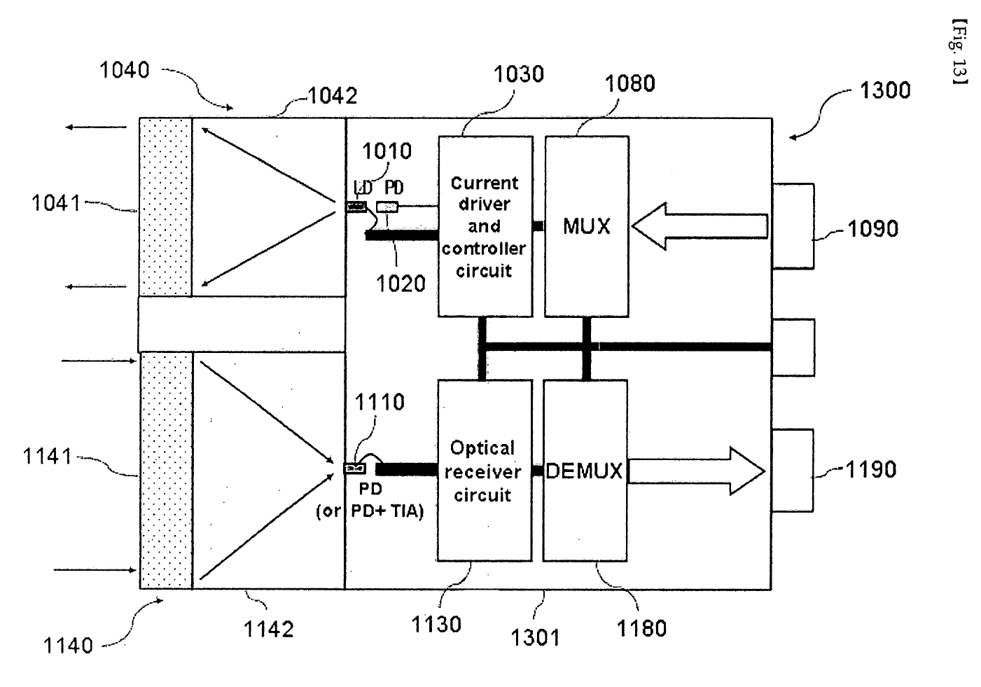

In case that the subscriber network is constituted as a ring network using ATM method, it is necessary to have add/drop function in which signals of some bandwidths among transmitted signals are distributed to the subscriber and signals received from the subscriber are added and transmitted with transmitted signals. FIG. 14 shows an example of a transponder for FSON having the above-described function.

In case of FSON system of ring network, directions of transmission and reception are generally different. Therefore, if the transceiver is manufactured as all-in-one type, it may be difficult to use for FSON system. In this regard, the transponder of FIG. 14 has separate transmitting part and receiving part.

As shown in FIG. 14, the receiving part includes a PD 1110, an optical receiver circuit 1130, and a DEMUX 1180 which are connected to the optical receiver circuit 1130 and has a drop port 1410 on a PCB 1401, which is integrated with a receiving optics module 1140. The transmitting part includes a MUX 1080 having an add port 1420, a current driver and controller circuit 1030 connected to the MUX 1080, an LD 1010, and a PD 1020 on a separate PCB 1402, which is integrated with a transmitting optics module 1040. The constitution of the other parts of the transmitting and receiving parts except the MUX/DEMUX 1080/1180 is similar to another examples described above.

As described above, if the transmitting part and the receiving part are formed as separate modules, it can be easily installed though the directions of transmission and reception are different.

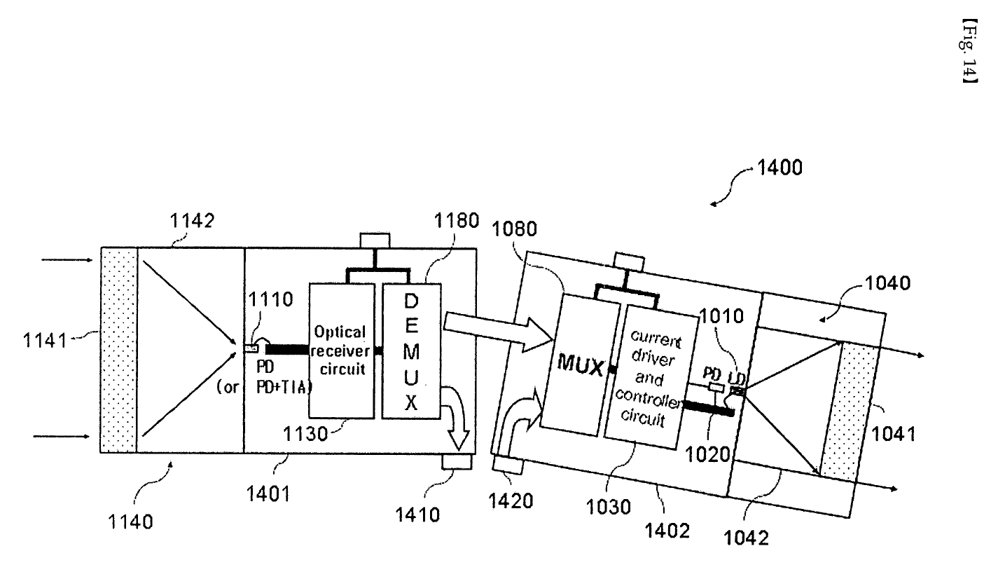

Alternatively, as shown in FIG. 15, it is possible for the transmitting part, receiving part, and MUX/DEMUX part to be placed in separate places. That is, the receiving part is formed on a PCB 1501, the transmitting part is formed on another PCB 1503, and a DEMUX 1180 and a MUX 1080 having a drop port 1510 and a add port 1520, respectively, are formed on another PCB 1502 placed between the receiving part and the transmitting part. If the transponder is formed to have three separate parts, the installation becomes much easier because the alignments of the transmitting part and the receiving part can be performed separately and easily.

In the meantime, it is possible to form optics module and circuit part as separate modules and connect two modules using flexible wires. In this case, the flexibility of the installation increases much more.

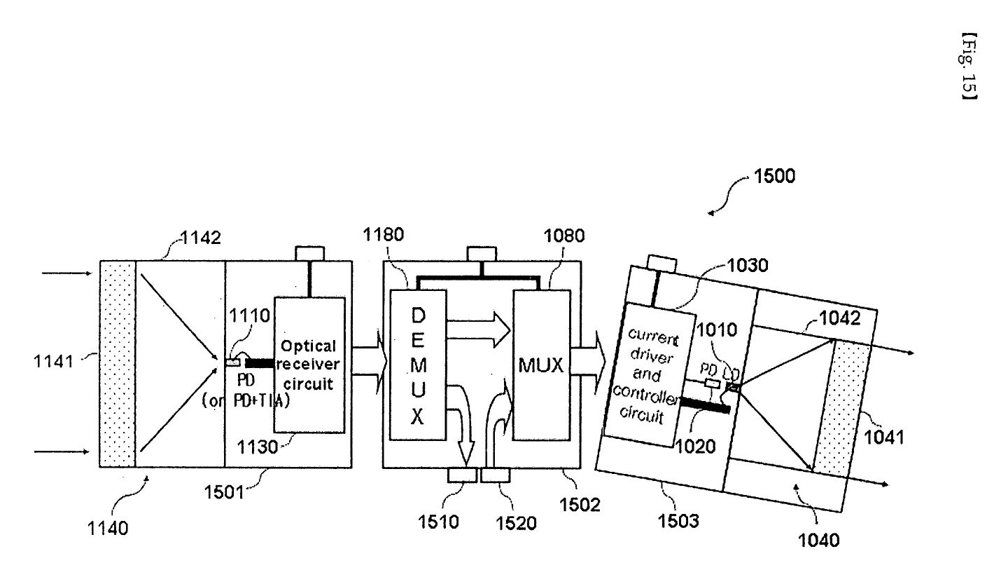

FIGS. 16 through 18 show the transmitter, receiver, and transceiver formed as described.

First, the constitution of the transmitter 1600 is described (FIG. 16). An optics module 1610 including a lens 1613 and a lens holder 1612 to adjust the focal distance of the lens 1613 as similar to another embodiments described above is formed, and a photo device module 1611 including an LD and PD is formed on the opposite side of the lens 1613 of the optics module 1610. A current driver and controller module 1620 separate from the optics module 1610 is formed using a PCB, etc. The photo device module 1611 can be connected to the current driver and controller module 1620 via a flexible wire 1630. The other structures are similar to the transmitter for FSON of the present invention, and all characteristics of the transmitter described above can be applied to the transmitter shown in FIG. 16.

If the optics module and circuit part are formed separately and they are connected to each other via a flexible wire, weight and size of the modules to be aligned become minimized to make the alignment stable and reliable and to make the installment flexible.

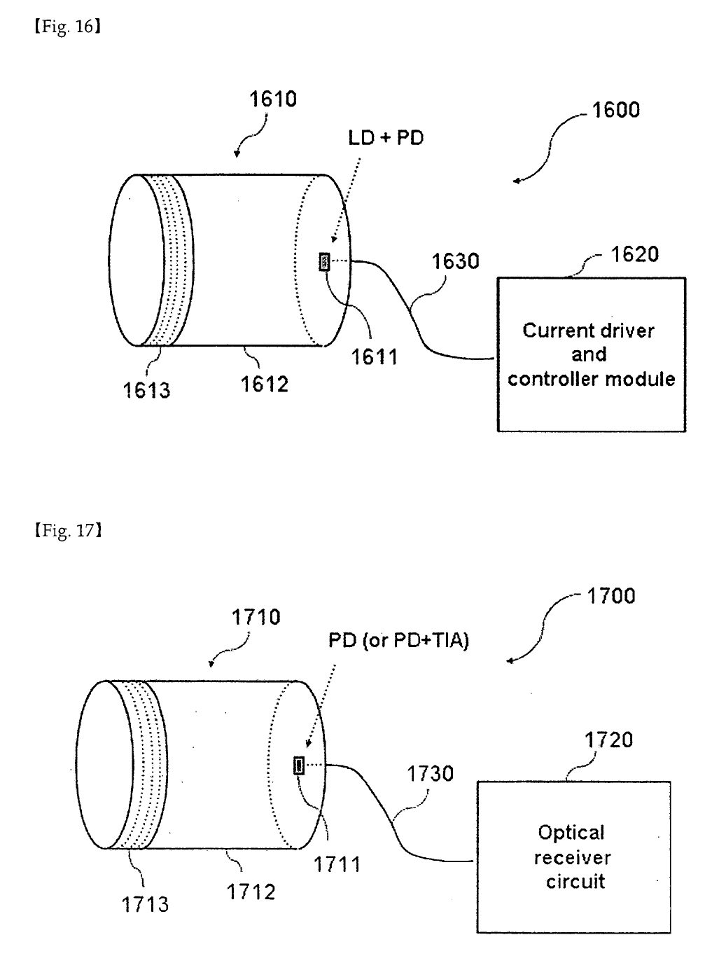

The receiver 1700 can be formed in similar way. As shown in FIG. 17, After forming a photo detecting module 1711 on a side of an optics module 1710 including a lens 1713 and a lens holder 1712, it is connected to an optical receiver circuit 1720 formed separately via a flexible electric wire 1730. The photo detecting module 1711 can be formed as a photo detecting device or both a photo detecting device and a pre-amplifier. In addition, all characteristics of the receiver described above can be applied to the receiver shown in FIG. 17.

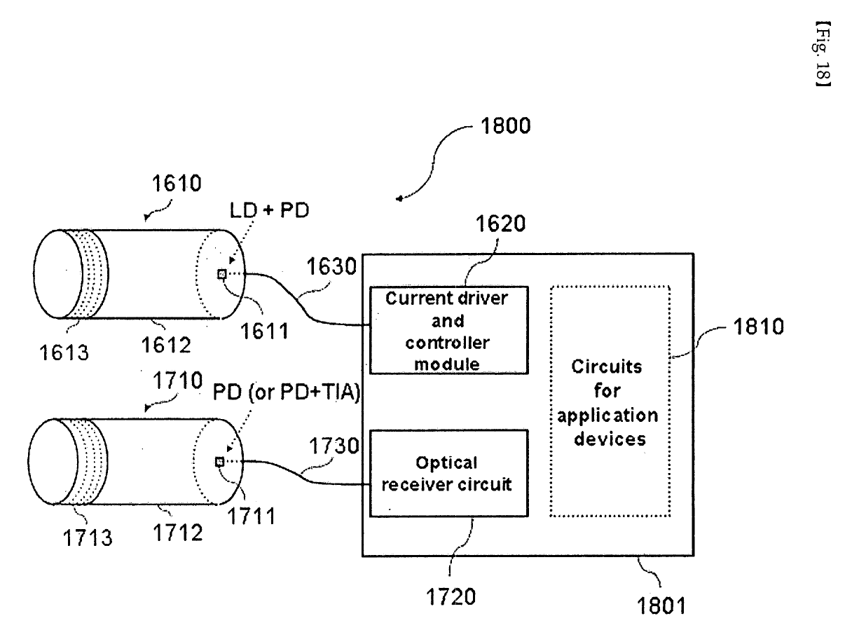

FIG. 18 is a schematic diagram of a transceiver formed by composing the transmitter and the receiver shown in FIGS. 16 and 17, respectively. A transmitting optics module 1610 and a receiving optics module 1710 are formed to have a photo device module (LD/PD) (for transmitting optics module) 1611 and a photo detecting module (PD or PD/ITA) (for receiving optics module) 1711, respectively, and they are connected to a current driver and controller circuit 1620 and an optical receiver circuit 1720, which are formed on the same substrate, via two flexible electric wires 1630 and 1730, respectively. Another circuit parts for various application devices can be formed together with the current driver and controller circuit 1620 and the optical receiver circuit 1720 on the PCB 1801. For example, a circuit having a function of the media converter, MUX/DEMUX circuits having add/drop functions, etc. can be included on the substrate.

While the present invention has been described in detail with reference to the preferred embodiments, it is to be understood that the invention is not limited to the disclosed embodiments, but, on the contrary, is intended to cover various modifications and equivalent arrangements included within the sprit and scope of the appended claims.

### INDUSTRIAL APPLICABILITY

The OWLL and FSON system having various advantages comparing to the conventional optical fiber communication system can be established using the transmitter, receiver, and application devices thereof according to the present invention. In addition, the transmitter, receiver, and application devices thereof according to the present invention are small, light, cheap, and standardized. At the same time, the transmitter, receiver, and application devices thereof according to the present invention can provide various functions required in the FSON system, and they provide those functions stably and reliably.

1. A transmitter for Free Space Optical Communication comprising:
a light source formed on a printed circuit board;
a photo detector formed on said printed circuit board for detecting the light from said light source;
a current driver and controller circuit integrally formed on said printed circuit board having a first terminal for receiving input signals, a second terminal for bias-in, a third terminal connected to said light source for outputting output signals to said light source and a fourth terminal connected to said photo detector for receiving output control signals for controlling the output of said light source from said photo detector;
an optics module formed to be assembled with said printed circuit board for receiving the light from said light source and transmitting the received light to the external free space.

2. The transmitter of claim 1, wherein
said light source is a laser diode or a light emitting diode.

3. The transmitter of claim 1, wherein
said light source and said photo detector are bonded to said printed circuit board using flip-chip bonding method.

4. The transmitter of claim 1, wherein said current driver and controller circuit comprises:
a light source driver circuit for driving said light source by outputting pulse via said first terminal; and
an automatic output control circuit for controlling the output of said light source driver circuit according to the output control signal inputted via said fourth terminal.

5. The transmitter of claim 1, wherein said optics module comprises:
a lens; and
a lens holder being able to adjust the focal length of said lens.

6. The transmitter of claim 1, wherein
said lens is an aspheric lens or a Fresnel lens.

7. The transmitter of claim 1, wherein
the output power of said light source and the magnitude of driving current of said current driver and controller circuit are adjusted to have appropriate values according to the transmission distance of said transmitter.

8. The transmitter of claim 1, further comprising:
a first screw unit formed to be integrated or assembled with said printed circuit board; and
a second screw unit formed to be integrated or assembled with said optics module;
wherein said printed circuit board and said optics module are assembled using said first and second screw units.

9. The transmitter of claim 8, wherein
said first and second screw units are standardized whereby various optics modules having lenses of different sizes can be assembled with said printed circuit board.

10. The transmitter of claim 1, wherein
the light from said transmitter is eye-safe.

11. A receiver for Free Space Optical Communication comprising:
a photo-detecting module including a photo detector formed on a printed circuit board;
an optical receiver circuit, integrally formed on said printed circuit board, having a first terminal connected to said photo-detecting module for receiving input signals from said photo-detecting module, a second terminal for bias-in, and a third terminal for outputting electric signals generated by transforming the input signals from said photo-detecting module; and
an optics module formed to be assembled with said printed circuit board for receiving the light from the external free space and transmitting the received light to said photo detector of said photo-detecting module.

12. The receiver of claim 11, wherein
said photo-detecting module includes a preamplifier, formed on said printed circuit board and connected to said photo detector, for amplifying the signals obtained from said photo detector.

13. The receiver of claim 12, wherein said optical receiver circuit comprises:
a signal amplifier for amplifying the signals transferred from said photo-detecting module via said first terminal;
an automatic gain controller for controlling the gain of said signal amplifier;
a data recovery circuit for recovering data from the signals transferred from said signal amplifier; and
a clock generator for generating clock signals using the signals transferred from said signal amplifier and transferring said clock signals to said data recovery circuit.

14. The receiver of claim 11, wherein said optical receiver circuit comprises:
a preamplifier formed on said printed circuit board and connected to said photo detector for amplifying the signals obtained from said photo detector,
a signal amplifier for amplifying the signals transferred from said photo-detecting module via said first terminal;
an automatic gain controller for controlling the gain of said signal amplifier;
a data recovery circuit for recovering data from the signals transferred from said signal amplifier; and
a clock generator for generating clock signals using the signals transferred from said signal amplifier and transferring said clock signals to said data recovery circuit.

15. The receiver of claim 11, wherein
said optical receiver circuit has a fourth terminal for monitoring the magnitude of input signals at the outside of said optical receiver circuit.

16. The receiver of claim 15, further comprising
a display unit connected to said fourth terminal for displaying said magnitude of input signals.

17. The receiver of claim 15, wherein
said magnitude of input signals can be transferred to the base station at the outside of said receiver.

18. The receiver of claim 11, wherein said optics module comprises:
a lens; and
a lens holder being able to adjust the focal length of said lens.

19. The receiver of claim 18, wherein
said lens is an aspheric lens or a Fresnel lens.

20. The receiver of claim 11, further comprising:
a first screw unit formed to be integrated or assembled with said printed circuit board; and
a second screw unit formed to be integrated or assembled with said optics module;
wherein said printed circuit board and said optics module are assembled using said first and second screw units.

21. The receiver of claim 20, wherein
said first and second screw units are standardized whereby various optics modules having lenses of different sizes can be assembled with said printed circuit board.

22. A transceiver for Free Space Optical Communication comprising:
a first light source formed on a printed circuit board;
a first photo detector formed on said printed circuit board for detecting the light from said first light source;
a first current driver and controller circuit integrally formed on said printed circuit board having a first terminal for receiving input signals, a second terminal for bias-in, a third terminal connected to said first light source for outputting output signals to said first light source, and a fourth terminal connected to said first photo detector for receiving output control signals for controlling the output power of said first light source from said first photo detector;
a transmitting optics module formed to be assembled with said printed circuit board for receiving the light from said first light source and transmitting the received light to the external free space;
a photo-detecting module including a second photo detector formed on said printed circuit board;
a first optical receiver circuit integrally formed on said printed circuit board having a fifth terminal connected to said photo-detecting module for receiving input signals from said photo-detecting module, a sixth terminal for bias-in, and a seventh terminal for outputting electric signals generated by transforming the input signals from said photo-detecting module; and
a receiving optics module formed to be assembled with said printed circuit board for receiving the light from the external free space and transmitting the received light to said second photo detector of said photo-detecting module.

23. The transceiver of claim 22, wherein
said photo-detecting module includes a preamplifier formed on said printed circuit board and connected to said second photo detector for amplifying the signals obtained from said second photo detector.

24. The transceiver of claim 23, wherein said first optical receiver circuit comprises:
a signal amplifier for amplifying the signals transferred from said photo-detecting module via said fifth terminal;
an automatic gain controller for controlling the gain of said signal amplifier;
a data recovery circuit for recovering data from the signals transferred from said signal amplifier; and
a clock generator for generating clock signals using the signals transferred from said signal amplifier and transferring said clock signals to said data recovery circuit.

25. The transceiver of claim 22, wherein said first optical receiver circuit comprises:
a preamplifier for amplifying the signals obtained from said second photo detector of said photo-detecting module via said fifth terminal;
a signal amplifier for amplifying the signals transferred from said preamplifier;
an automatic gain controller for controlling the gain of said signal amplifier;
a data recovery circuit for recovering data from the signals transferred from said signal amplifier; and
a clock generator for generating clock signals using the signals transferred from said signal amplifier and transferring said clock signals to said data recovery circuit.

26. The transceiver of claim 22, wherein said first current driver and controller circuit comprises:
a light source driver circuit for driving said first light source by outputting pulse via said first terminal; and
an automatic output control circuit for controlling the output of said light source driver circuit according to the output control signals inputted via said fourth terminal.

27. The transceiver of claim 22, wherein
said first light source is a laser diode or a light emitting diode.

28. The transceiver of claim 22, wherein
said first light source and said first and second photo detectors are bonded to said printed circuit board using flip-chip bonding method.

29. The transceiver of claim 22, wherein said transmitting optics module comprises:
a first lens; and
a first lens holder being able to adjust the focal length of said first lens.

30. The transceiver of claim 29, wherein
said first lens is an aspheric lens or a Fresnel lens.

31. The transceiver of claim 22, wherein said receiving optics module comprises:
a second lens; and
a second lens holder being able to adjust the focal length of said second lens.

32. The transceiver of claim 31, wherein
said second lens is an aspheric lens or a Fresnel lens.

33. The transceiver of claim 22, wherein
said first optical receiver circuit comprises a eighth terminal for monitoring the magnitude of input signals at the outside of said first optical receiver circuit.

34. The transceiver of claim 33, further comprising
a display unit connected to said eighth terminal for displaying said magnitude of input signals.

35. The transceiver of claim 33,
wherein said magnitude of input signals can be transferred to the base station at the outside of said transceiver.

36. The transceiver of claim 22, further comprising:
a first screw unit formed to be integrated or assembled with said printed circuit board adjacent with the part of printed circuit board where said first light source, said first photo detector and said first current driver and controller circuit are formed;
a second screw unit formed to be integrated or assembled with said printed circuit board adjacent with the part of printed circuit board where said photo-detecting module and said first optical receiver circuit are formed;
a third screw unit formed to be integrated or assembled with said transmitting optics module; and
a fourth screw unit formed to be integrated or assembled with said receiving optics module;
wherein said printed circuit board and said transmitting optics module are assembled using said first and third screw units; and
wherein said printed circuit board and said receiving optics module are assembled using said second and fourth screw units.

37. The transceiver of claim 22, wherein
said transmitting optics module and said receiving optics module face to the same side.

38. The transceiver of claim 22, wherein
said transmitting optics module and said receiving optics module have the same configuration.

39. The transceiver of claim 22, wherein
said transmitting optics module and said receiving optics module have different configurations from each other.

40. The transceiver of claim 22, wherein
the light from said transmitting optics module is eye-safe.

41. The transceiver of claim 22, further comprising:
a second optical receiver circuit integrally formed on said printed circuit board and connected to the first terminal of said first current driver and controller circuit;
a third photo detector formed on said printed circuit board and connected to said second optical receiver circuit;
a second current driver and controller circuit integrally formed on said printed circuit board and connected to the seventh terminal of said first optical receiver circuit; and
a second light source formed on said printed circuit board, connected to said second current driver and controller circuit.

42. The transceiver of claim 41, further comprising:
a first optical fiber connected to said third photo detector;
a second optical fiber connected to said second light source; and
a media converter connected to said first and second optical fibers and having UTP (unshielded twisted-pair) port.

43. The transceiver of claim 41, wherein
said second light source is laser diode or light emitting diode.

44. The transceiver of claim 22, further comprising:
a media converter circuit formed on said printed circuit board, connected to said first terminal of said first current driver and controller circuit and said seventh terminal of said first optical receiver circuit and having UTP port.

45. A transponder for Free Space Optical Communication comprising:
a light source formed on a printed circuit board;
a first photo detector formed on said printed circuit board for detecting the light from said first light source;
a first current driver and controller circuit, integrally formed on said printed circuit board, having a first terminal for receiving input signals, a second terminal for bias-in, a third terminal connected to said first light source for outputting output signals to said first light source and a fourth terminal connected to said first photo detector for receiving output control signals for controlling the output of said first light source from said first photo detector;
a multiplexer, formed on said printed circuit board and connected to said first terminal of said current driver and controller circuit, for multiplexing input signals to output to said current driver and controller circuit via said first terminal;
a transmitting optics module formed to be assembled with said printed circuit board for receiving the light from said first light source and transmitting the received light to the external free space;
a photo-detecting module including a second photo detector formed on said printed circuit board;
a first optical receiver circuit, integrally formed on said printed circuit board, having a fifth terminal connected to said photo-detecting module for receiving input signals from said photo-detecting module, a sixth terminal for bias-in, and a seventh terminal for outputting electric signals generated by transforming the input signals from said photo-detecting module;
a demultiplexer, formed on said printed circuit board and connected to said seventh terminal of said optical receiver circuit, for receiving signals from said optical receiver circuit and outputting demultiplexed signals; and
a receiving optics module formed to be assembled with said printed circuit board for receiving the light from the external free space and transmitting the receiving light to said second photo detector of said photo-detecting module.

46. A transponder for Free Space Optical Communication comprising:
a photo-detecting module including a first photo detector formed on a first printed circuit board;
a first optical receiver circuit, integrally formed on said first printed circuit board, having a first terminal connected to said photo-detecting module for receiving input signals from said first photo-detecting module, a second terminal for bias-in, and a third terminal for outputting electric signals generated by transforming the input signals from said photo-detecting module;
a demultiplexer, formed on said first printed circuit board, having an input port connected to said third terminal of said optical receiver circuit for receiving signals from said optical receiver circuit, a drop port for distributing a part of demultiplexed signals, and an output port for outputting the rest of said demultiplexed signals;
a receiving optics module formed to be assembled with said first printed circuit board for receiving the light from the external free space and transmitting the received light to said first photo detector of said photo-detecting module;
a light source formed on a second printed circuit board;
a second photo detector formed on said second printed circuit board for detecting the light from said light source;
a current driver and controller circuit, integrally formed on said second printed circuit board, having a fourth terminal for receiving input signals, a fifth terminal for bias-in, a sixth terminal connected to said light source for outputting output signals to said light source and a seventh terminal connected to said second photo detector for receiving output control signals for controlling the output of said light source from said second photo detector;
a multiplexer, formed on said second printed circuit board, having an input port for receiving signals from said output port of said demultiplexer, an add port for receiving additional signals from the outside, and an output port for outputting multiplexed signal to said current driver and controller circuit; and
a transmitting optics module formed to be assembled with said second printed circuit board for receiving the light from said light source and transmitting the received light to the external free space.

47. A transponder for Free Space Optical Communication comprising:
a photo-detecting module including a first photo detector formed on a first printed circuit board;
an optical receiver circuit, integrally formed on said first printed circuit board, having a first terminal connected to said photo-detecting module for receiving input signals from said photo-detecting module, a second terminal for bias-in, and a third terminal for outputting electric signals generated by transforming the input signals from said photo-detecting module;
a receiving optics module formed to be assembled with said first printed circuit board for receiving the light from the external free space and transmitting the received light to said first photo detector of said photo-detecting module;
a demultiplexer, formed on a second printed circuit board, having an input port connected to said third terminal of said optical receiver circuit for receiving signals from said optical receiver circuit, a drop port for distributing a part of demultiplexed signals, and an output port for outputting the rest of said demultiplexed signals;
a multiplexer, formed on said second printed circuit board, having an input port for receiving signals from said output port of said demultiplexer, an add port for receiving additional signals from the outside, and an output port for outputting multiplexed signal to said current driver and controller circuit;
a light source formed on a third printed circuit board;
a second photo detector formed on said third printed circuit board for detecting the light from said light source;
a current driver and controller circuit, integrally formed on said third printed circuit board, having a fourth terminal for receiving input signals, a fifth terminal for bias-in, a third terminal connected to said light source for outputting output signals to said light source, and a seventh terminal connected to said second photo detector for receiving output control signals for controlling the output of said light source from said second photo detector; and
a transmitting optics module formed to be assembled with said printed circuit board for receiving the light from said light source and transmitting the received light to the external free space.

48. A transmitter for Free Space Optical Communication comprising:
a photo-optics module including a light source, a photo detector for detecting the light from said light source, and an optics module, formed to be integrated with said light source and said photo detector, for receiving the light from said light source and transmitting the received light to the external free space; and
a current driver and controller circuit, integrally formed on a printed circuit board, having a first terminal for receiving input signals, a second terminal for bias-in, a third terminal connected to said light source for outputting output signals to said light source, and a fourth terminal connected to said photo detector for receiving output control signals for controlling the output of said light source from said photo detector;
wherein said light source and said photo detector are connected to said third terminal and said fourth terminal respectively with flexible wires.

49. A receiver for Free Space Optical Communication comprising:
a photo-optics module including a photo-detecting module having a photo detector, and an optics module formed to be integrated with said photo-detecting module for receiving the light from the external free space and transmitting the light to said photo detector of said photo-detecting module; and
an optical receiver circuit, integrally formed on a printed circuit board, having a first terminal connected to said photo-detecting module for receiving input signals from said photo-detecting module, a second terminal for bias-in, and a third terminal for outputting electric signals generated by transforming the input signals from said photo-detecting module;
wherein said photo detector and said third terminal are connected with flexible wire.

50. A transceiver for Free Space Optical Communication comprising:
a transmitting photo-optics module including a light source, a first photo detector for detecting the light from said light source, and a transmitting optics module, formed to be integrated with said light source and said first photo detector, for receiving the light from said light source and transmitting the received light to the external free space;
a receiving photo-optics module including a photo-detecting module having a second photo detector, and a receiving optics module formed to be integrated with said photo-detecting module for receiving the light from the external free space and transmitting the received light to said second photo detector of said photo-detecting module;
a current driver and controller circuit, integrally formed on a printed circuit board, having a first terminal for receiving input signals, a second terminal for bias-in, a third terminal connected to said light source for outputting output signals to said light source, and a fourth terminal connected to said first photo detector for receiving output control signals for controlling the output of said light source from said first photo detector; and
an optical receiver circuit, integrally formed on said printed circuit board, having a fifth terminal connected to said photo-detecting module for receiving input signals from said photo-detecting module, a sixth terminal for bias-in, and a seventh terminal for outputting electric signals generated by transforming the input signal from said photo-detecting module;
wherein said light source and said first photo detector are connected to said third terminal and said fourth terminal respectively with flexible wires; and
wherein said second photo detector and said seventh terminal are connected with a flexible wire.
